(19) United States
(12) Patent Application Publication
(10) Pub. No.: US 2011/0056924 A1
(43) Pub. Date: Mar. 10, 2011

(54) Solar defrost panels

(76) Inventor: Benjamin Park Townsend, Schaumburg, IL (US)

(21) Appl. No.: 12/584,681

(22) Filed: Sep. 10, 2009

(51) Int. Cl. H05B 1/00; H05B 3/06; H05B 3/08

(52) U.S. Cl. 219/213; 219/542; 219/541

(57) ABSTRACT

A solar defrost panel has a photovoltaic panel with an integrated electrical defrost system. The electrical defrost system has an electrical heating element that overlays the photovoltaic panel. The electrical defrost system can remove snow, frost and ice from the solar defrost panel and prevent snow, frost and ice from accumulating on the solar defrost panel. The electrical defrost system can have a controller to automatically or manually control operation of the electrical heating element. The controller can be located inside of a building for convenience of the user. The solar defrost panel provides clearing of snow, frost and ice from the solar defrost panel which can allow the photovoltaic panel to operate effectively during winter and in cold climate regions.

### BACKGROUND OF THE INVENTION

This invention relates to solar panels. More specifically, this invention relates to solar panels having a defroster or solar defrost panels. Embodiments of the present invention provide a solar defrost panel which can melt snow, frost and ice on the solar panel which allows the solar panel to be more useful in cold climates. The present invention also pertains to related methods, including methods of operating solar defrost panels and methods of making solar defrost panels. At least one embodiment of the present invention is described in the context of a solar defrost panel. However, the present invention is not limited to a particular embodiment and may be practiced in other embodiments, as well.

Solar panels are well known and commonly used to convert solar energy to electrical energy. Solar panel technology has advanced greatly during the last few decades. However, existing solar panels have limitations and can be improved. For example, solar panels may have limitations as a source of renewable energy in some regions of the world. In colder climate regions, snow, frost and ice can accumulate on the solar panels and reduce or even eliminate sunlight from reaching the photovoltaic cells. Accordingly, the solar panel's ability to produce electricity can be reduced or even eliminated. The problems associated with snow, frost and ice build-up on solar panels can be worse when the winter season is relatively long or harsh. Large amounts of snow, the frequency of snow fall and low temperature climates can also worsen the problems with snow, frost and ice build-up on solar panels. Furthermore, the duration of sunlight hours during the day can be limited for colder climate regions and solar panels need to be used more effectively during the limited available daylight.

Solar panels have been cleared of snow, frost and ice by waiting until sunlight warms the solar panel and melts the snow, frost and ice. Also, one could wait until the ambient temperature increases above freezing to melt the snow, frost and ice. Obviously, these methods of removing snow, frost and ice from solar panels can be time consuming, ineffective and may not even work for extended periods of time, e.g., days, weeks or even months.

Existing solar panels have also been manually cleared of snow, frost and ice. Manually clearing solar panels of snow, frost and ice requires one to frequently battle nature whenever the build-up occurs. In cold climate regions, one may have to repeatedly manually clear snow, frost, and ice buildup from the solar panel systems. Manual clearing of snow, frost and ice from solar panels can be time consuming, inefficient and expensive. Also, solar panels are frequently located in difficult to reach places, such as on rooftops. The safety of a person who must be on a rooftop or ladder during cold, snow and ice conditions to manually clear the snow, frost, and ice from the solar panels can be a significant concern.

Thus, needs exist for new solar panels, such as solar defrost panels, for the reasons mentioned above and for other reasons. It would be an improvement to provide a new solar panel having a defroster.

### SUMMARY OF THE INVENTION

The present invention provides new solar defrost panels. The solar defrost panels have a heater that can remove snow, frost and ice from the solar defrost panels. The present invention also provides new heaters or defroster units which can be included in a solar panel to remove snow, frost and ice from the solar panel.

The term “defrost” is used in relation to the present invention. The term “defrost” is not limited to removing only frost. The term “defrost” also contemplates removing snow, ice and other frozen liquids. The term “defrost” as it relates to the present invention can also contemplate increasing the temperature sufficiently to remove snow, frost, ice or other frozen liquid.

Embodiments of the solar defrost panel have an integrated electrical defrost system that overlays solar photovoltaic cell panels or other sun collecting solar panels. The electrical defrost system has a series of electrically conductive grid lines (such as metallic grid lines) that heat up when electric current passes through the grid lines. The increase in temperature prevents snow, frost and ice build up on the surface the solar panels and melts snow, frost and ice which has already been deposited on the solar panel.

The solar defrost panel may have a controller which controls operation of the electrical defrost system. The controller can automatically operate the electrical defrost system, for example, the controller can be set to automatically turn on the electrical defrost system before sunrise so that the solar defrost panels are clear of snow, frost and ice upon sunrise. The electrical defrost system can also be operated on an on-demand basis as needed. Also, the electrical defrost system can be operated or controlled from inside of a building.

In an embodiment of the present invention, a solar defrost panel has an energy converter that converts solar energy to electrical energy, and an electrical heater adjacent the energy converter such that a temperature of at least a portion of the solar defrost panel is increased when the electrical heater is electrically actuated.

The electrical heater may be an electrical resistance heating element.

The electrical heater may have a transparent panel and an electrical resistance heating element on a side of the transparent panel facing the energy converter.

The energy converter may have a photovoltaic panel which has a solar exposure side, and a first transparent panel above the solar exposure side of the photovoltaic panel. The electrical heater may have an electrical resistance heating element above the first transparent panel, and a second transparent panel above the electrical heating resistance element.

The solar defrost panel may further have a controller operatively connected to the electrical heater and controlling an operation of the electrical heater.

The electrical heating resistance element may have a plurality of elongated electrically conductive elements electrically connected together by bus bars.

The solar defrost panel may further have a battery electrically connected to an electrical output of the energy converter, and the battery may be electrically connected to the electrical heater.

In an embodiment of the present invention, a solar defrost panel has a photovoltaic panel having a solar exposure side, an electrical conductive heating element above the solar exposure side of the photovoltaic panel, an electrical insulator between the photovoltaic panel and the electrical conductive heating element, and a first transparent panel above the electrical conductive heating element.

The solar defrost panel may further have a second transparent panel between the solar exposure side of the photovoltaic panel and the electrical conductive heating element. The second transparent panel may be the electrical insulator.

The electrical conductive heating element may have a plurality of elongated electrically conductive elements electrically connected together by bus bars.

The solar defrost panel may further have a controller connected to the electrical conductive heating element and controlling operation of the electrical conductive heating element.

The solar defrost panel may further have a battery electrically connected to an electrical output of the photovoltaic panel, in which the battery electrically powers the electrical conductive heating element during a battery power mode.

The electrical conductive heating element may be electrically connected to an electrical output of the photovoltaic panel.

The solar defrost panel may further have an AC to DC converter in which a DC output of the AC to DC converter is electrically connected to the electrical conductive heating element.

In an embodiment of the present invention, a solar panel defroster has a flat transparent panel, an electrical conductive heating element adjacent the flat transparent panel, and a frame around an outer edge of the flat transparent panel.

The electrical conductive heating element may have a plurality of elongated electrically conductive elements electrically connected together by bus bars.

In an embodiment of the present invention, a method of heating a solar panel provides supplying electric current to an electrical conductive heating element, increasing a temperature of the electrical conductive heating element by the electric current passing through the electrical conductive heating element, and transferring heat energy from the electrical conductive heating element to at least a portion of the solar panel.

The step of transferring heat energy may provide transferring heat energy to an outermost solar exposure portion of the solar panel.

The step of supplying electric current may provide supplying electric current from a battery. The battery may be recharged with electrical output from the solar panel.

The step of supplying electric current may provide supplying electric current from an AC to DC converter.

The method of heating a solar panel may further provide controlling operation of the electrical conductive heating element with a programmable controller.

In an embodiment of the present invention, a method of operating a defroster of a solar panel may provide turning on an electrical heater of the solar panel, increasing a temperature of at least a portion of the solar panel with the electrical heater, and melting frozen water on the solar panel with the portion of the solar panel having the increased temperature.

The method of heating operating a defroster of a solar panel may further provide controlling operation of the electrical heater with a programmable controller.

In an embodiment of the present invention, a method of making a solar defrost panel provides overlaying an electrical heater layer on top of a solar energy to electrical energy converter.

The overlaying step may further provide overlaying a transparent panel carrying an electrical heater on top of the solar energy to electrical energy converter.

The method of making a solar defrost panel may further provide assembling the electrical heater layer and the solar energy to electrical energy converter together within a frame.

The overlaying step may further provide retrofitting the electrical heater layer onto a solar panel having the solar energy to electrical energy converter.

An advantage of the solar defrost panel can be that the electrical defrost system removes snow, frost and ice from the solar defrost panel.

Another advantage of the solar defrost panel can be that snow, frost and ice does not have to be manually removed from the solar defrost panel.

Another advantage of the solar defrost panel can be to increase the usage and efficiency of the solar defrost panel during the winter season.

A further advantage of the solar defrost panel can be to use solar defrost panels in cold climate regions.

Yet another advantage of the present invention can be to retrofit existing solar panels with the electrical defrost system.

Another advantage of the present invention can be to remove snow, frost and ice from solar defrost panels without having to climb on a ladder or a roof to manually clear solar panels during winter.

Embodiments of the present invention may have various features and provide various advantages. Any of the features and advantages of the present invention may be desired, but, are not necessarily required to practice the present invention.

### BRIEF DESCRIPTION OF THE FIGURES

FIG. 1 is a top perspective view of a solar defrost panel according to the present invention.

FIG. 2 is a bottom perspective view of the solar defrost panel of FIG. 1.

FIG. 3 is an exploded perspective view of the solar defrost panel of FIG. 1.

FIG. 4 is a top perspective view of an electrical heating element and a transparent panel of the solar defrost panel of FIG. 1.

FIG. 5 is a top perspective view of the electrical heating element and the transparent panel of FIG. 4 on a solar panel.

FIG. 6 is a bottom perspective view of the electrical heating element, the transparent panel and the solar panel of FIG. 5.

FIG. 7 is an enlarged partial view of FIG. 5.

FIG. 8 is an enlarged partial view of FIG. 6.

FIG. 9 is a schematic diagram a solar defrost panel array electrically connected to a control panel.

FIG. 10 is an enlarged schematic diagram of the control panel of FIG. 9.

FIG. 11 is a schematic diagram of the control panel connected to battery power.

FIG. 12 is a schematic diagram of the control panel connected to AC power.

FIG. 13 is a top perspective view of a solar panel defroster according to the present invention.

FIG. 14 is a bottom perspective view of the solar panel defroster of FIG. 13.

FIG. 15 is an exploded perspective view of the solar panel defroster of FIG. 13.

FIG. 16 is an enlarged partial view of the solar panel defroster of FIG. 13.

### DETAILED DESCRIPTION OF THE INVENTION

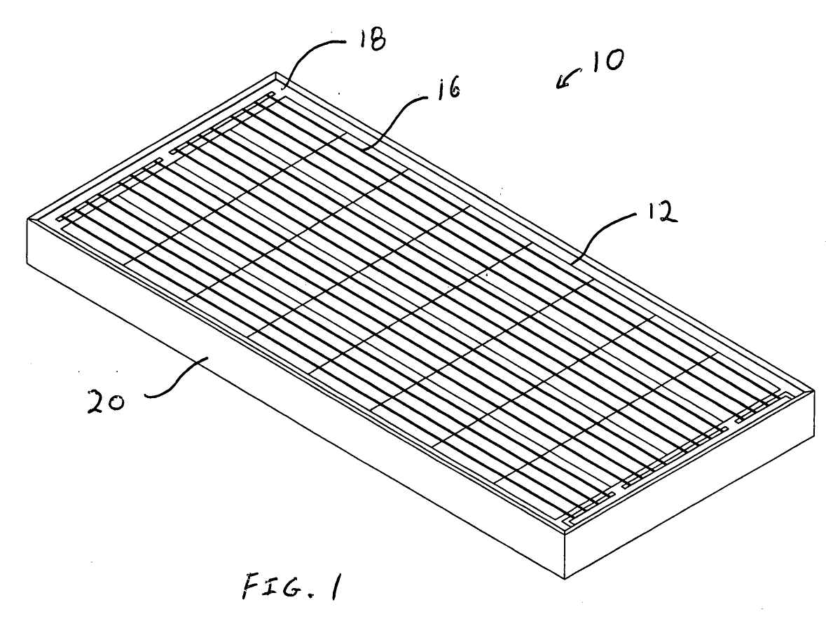

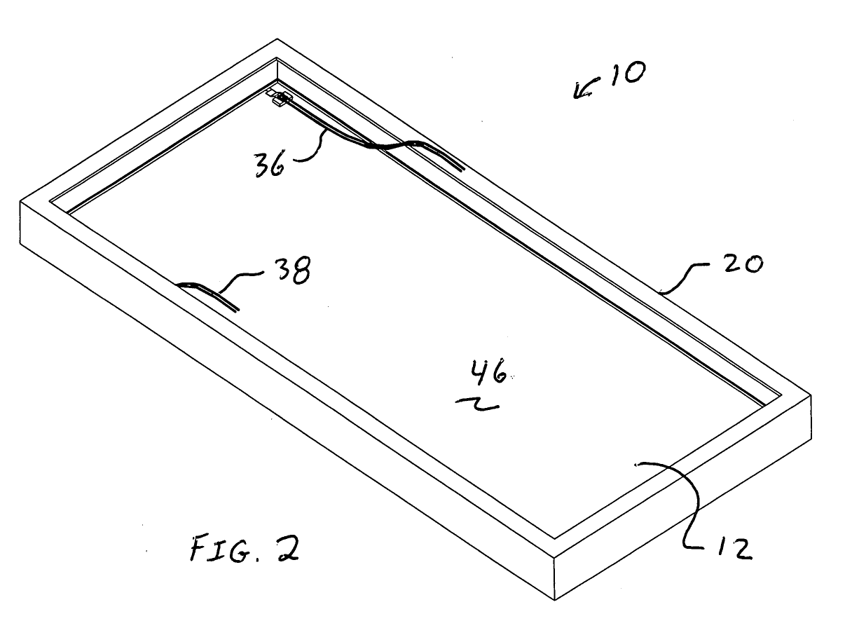

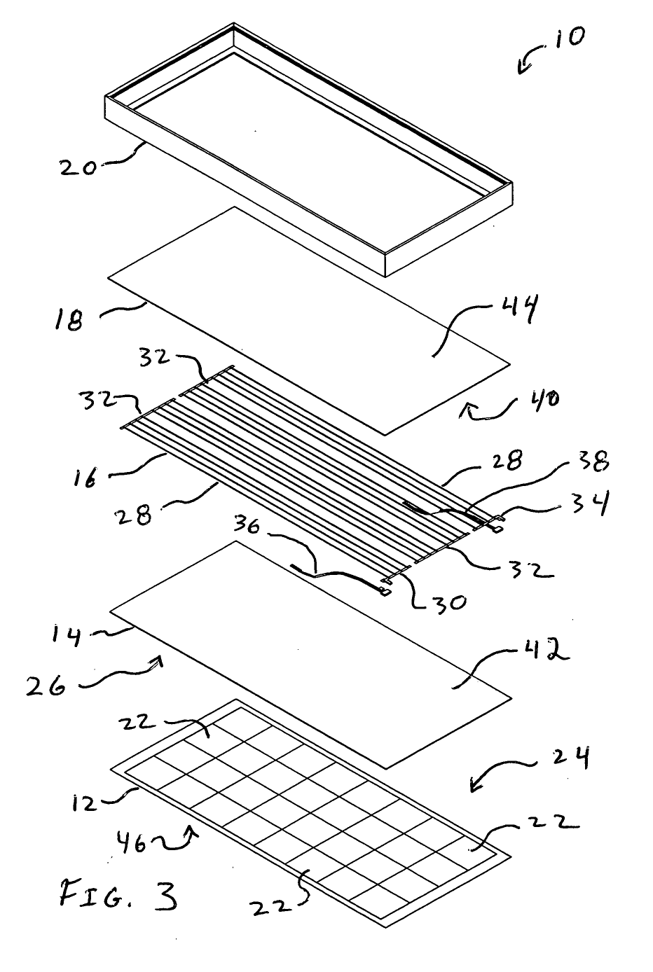

One example of a solar defrost panel 10 according to the present invention is shown in FIGS. 1-3. FIG. 1 shows a top view of the solar defrost panel 10, FIG. 2 shows a bottom view of the solar defrost panel 10 and FIG. 3 shows and exploded view of the solar defrost panel 10. The solar defrost panel 10 has a solar panel layer 12, a transparent panel 14, an electrical heating element or electrical heater 16, a transparent panel 18 and a frame 20.

The solar panel layer 12 has a plurality of photovoltaic cells 22 arranged in an array. The solar panel layer 12 has a solar exposure side 24 facing upward as viewed in FIG. 3. The solar panel layer 12 is bonded to the bottom side 26 of the transparent layer 14. The solar panel layer 12 and the transparent layer 14 together can be considered a solar panel. The photovoltaic cells 22, the solar panel layer 12 and the transparent panel 14 (the solar panel) can be existing components as known in the solar panel technology field. For example, the photovoltaic cells 22 can be wafers, thin films, and nanocells, etc. However, the present invention can be practiced with new solar panel technology as such technology becomes available. The solar panel layer 12 converts solar energy (sunlight) to electrical energy. The present invention can also be practiced with other energy converters that convert solar energy to electrical energy, including current and future technologies.

In the illustrated embodiment of the present invention, the electrical heating element 16 is an electrical resistance heating element. When electrical power is supplied to the electrical heating element 16, the electrical heating element 16 generates heat. The heat generated by the electrical resistance heating element 16 increases the temperature of the transparent panel 18 which removes snow, frost and ice from the solar defrost panel 12. The electrical heating element 16 can provide rapid heating, particularly when connected to a relatively high amperage circuit.

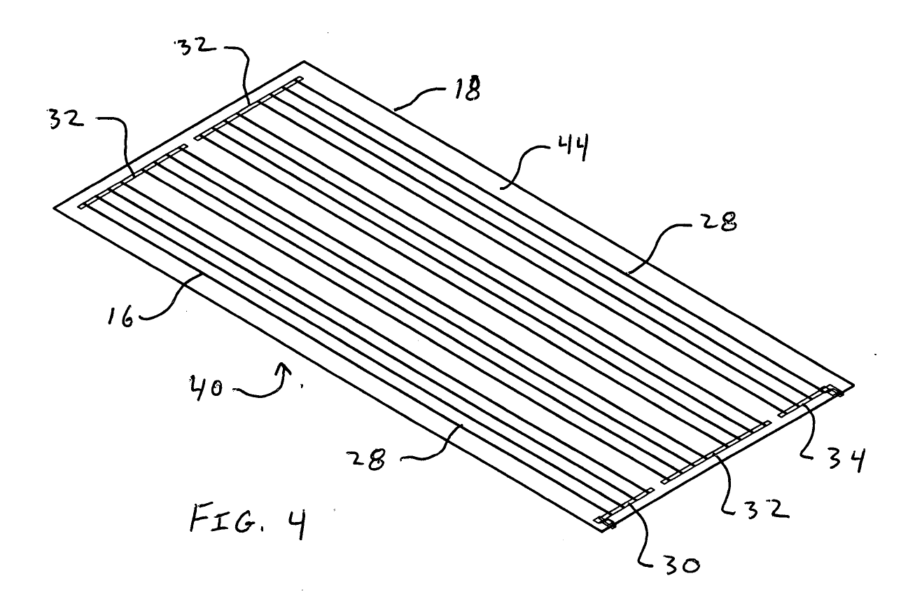

The electrical heating element 16 has a plurality of elongated electrically conductive elements 28 electrically connected together by electrically conductive bus bars 30, 32, 34. The electrical heating element 16 has leads 36, 38 for supplying electrical power to the electrical heating element 16. Referring also to FIG. 4, the electrical heating element 16 has a zigzag grid pattern with the elongated elements 28 extending parallel along the longer length of the transparent panel 18 and the bus bars 30, 32, 34 extending along the shorter width of the transparent panel 18. The electrical heating element 16 extends over substantially all of the surface of the transparent panel 18 to effectively heat substantially all of the transparent panel 18. Although a particular grid pattern of the electrical heating element 18 is shown in FIGS. 1, 3 and 4, the present invention can be practiced using other grid patterns as well.

The elongated heating elements 28 of the electrical heating element 16 can be made of any suitable material that generates heat when subjected to electrical current. It may be beneficial for the elongated heating elements 28, and the electrical heating element 16 itself, to have good electrical conductive properties and good heat generating properties at lower temperatures, such as temperatures below freezing. Some examples of suitable materials for the electrical heating element 16 include, without limitation, coppers, metallic films, aluminums, conductive coating platings, silver ceramic compounds, conductive inks, thermoplastic films, conductive metallic pastes, soldiers, synthetic metals, silver inks, silver pastes, other materials and combinations thereof.

The bus bars 30, 32, 34 of the electrical heating element 16 can be made of any suitable material that conducts electricity to the elongated elements 28. The bus bars 30, 32, 34 may also generate heat when subjected to electrical current, if so desired. It may be beneficial for the bus bars 30, 32, 34 to have good electrical conductive properties and good heat generating properties at lower temperatures, such as temperatures below freezing. Some examples of suitable materials for the bus bars 30, 32, 34 include, without limitation, aluminums, coppers, brasses, copper clad aluminums, synthetic metals, conductive coating platings, silvers, solid materials, laminated materials, flat flexible materials, wave crimp cables, other materials and combinations thereof.

Referring to FIGS. 1, 3 and 4, the electrical heating element 16 can be attached to the transparent panel 18, particularly, attached to a bottom surface 40 of the transparent panel 18. The transparent panel 18 and the electrical heating element 16 are positioned above the solar panel layer 12, i.e., overlay the solar panel layer 12 on the top side (solar exposure side 24) of the solar panel layer 12. The electrical heating element 16 can be attached to the transparent panel 18 in any suitable manner. An advantage to attaching the electrical heating element 16 to the transparent panel 18 is that the electrical heating element 16 and transparent panel 18 assembly can be placed on top of or overlay an existing solar panel to form the solar defrost panel 10.

However, the present invention can be practice using other structures as well. For example, one alternative would be to attach the electrical heating element 16 to the top surface 42 of the transparent panel 14. Another alternative would be not to attach the electrical heating element 16 to either of the transparent panels 14, 18, but rather, hold the electrical heating element 16 in place between the two transparent panels 14, 18, for example by pressure or by bonding the transparent panels 14, 18 to each other. Further alternatives would be to imbed the electrical heating element 16 in the material of the transparent panel 18 or the transparent panel 14, i.e., encase the electrical heating element 16 in the material of either transparent panel 14, 18.

The electrical heating element 16 is electrically conductive as are the photovoltaic cells 22 of the solar panel layer 12. The photovoltaic cells 22 of the solar panel layer 12 and the electrical heating element 16 should be electrically insulated from each other to avoid an electrical short between them. The transparent panel 14 provides electrical insulation between the solar panel layer 12 and the electrical heating element 16. Similarly, the transparent panel 18 also covers and electrically insulates the electrical heating element 16. The electrical heating element 16 can be electrically insulated from other portions of the solar defrost panel 10 by other means than being sandwiched between the two transparent layers 14, 18. For example, the electrical heating element 16 could be coated with an electrical insulator or an electrical insulating film could cover the electrical heating element 16. One of the transparent panels 14, 18 may not be needed by using other means to electrically insulate the electrical heating element 16.

The transparent panel 18 can carry the electrical heating element 16 as mentioned above. The transparent panel 18 provides a closed top for the solar defrost panel 12 which protects the solar defrost panel 12 from the environment. The transparent panel 18 can provide extra protection from the outside environment by having an additional layer of tempered glass/high density clear plastic to current solar cell panels. The transparent panel 18 is, of course, transparent to sunlight to allow the sunlight to pass through the transparent panel 18 to reach the solar panel layer 12. The transparent panel 18 may also have other properties that may be beneficial to the solar defrost panel 12, for example, without limitation, impact resistant, weather resistant, resistant to degradation from sunlight, electrical insulator, strong, light weight, high density, and heat conductive. The transparent panel 18 conducts heat from the electrical heating element 16 to a top surface 44 of the transparent panel 18 to melt any snow, frost and ice on the solar defrost panel 12.

The transparent panel 18 can be made of a wide variety of materials suitable for use in the solar defrost panel 12. Some examples of suitable materials for the transparent panel 18 include, without limitation, glasses, tempered glasses, annealed glasses, architectural glasses, fire resistant glasses, toughen glasses, tempered laminated glasses, laminated glasses, low-e glasses, plastics, clear plastics, polycarbonates, acrylics, fiberglasses, thermoplastics, plexiglasses, lucites, acetals, and other materials and combinations thereof. Furthermore, although the illustrated embodiment of the present invention shows the transparent panel 18 as a single layer, the transparent panel 18 can have multiple layers, including multiple layers of the same or different materials.

The sandwich of the transparent panel 18, the electrical heating element 16 and the transparent panel 14 may form an air gap or pocket between the transparent panels 14, 18. Preferably, the air pocket is sealed closed, for example, the perimeter edges of the transparent panels 14, 18 are sealed when sealed to the frame 20. The electrical heating element 16 heats the air in the air pocket which heats the transparent panel 18 to remove snow, frost and ice from the solar defrost panel 10 or prevent snow, frost or ice from accumulating on the solar defrost panel 10. The heated air pocket may heat the transparent panel 18 more uniformly and quickly and maintain heat longer after the electrical heating element 16 is turned off. The electrical heating element 16 can also heat the transparent panel 18 directly by being in contact with the transparent panel 18.

The frame 20 extends around an outer perimeter of the combined solar panel layer 12, the transparent panel 14, the electrical heating element 16 and the transparent panel 18. The frame 20 holds all of those components of the solar defrost panel 10 together. A seal (not shown), for example an appropriate caulk, can be used around the frame 20 to provide a liquid tight seal between the frame 20 and the combined solar panel layer 12, the transparent panel 14, the electrical heating element 16 and the transparent panel 18. Structures other than the frame 20 can be used to hold the combined solar panel layer 12, the transparent panel 14, the electrical heating element 16 and the transparent panel 18 together. Also, any suitable sealing means can be used instead of caulk. The frame 20 can be made of any suitable material, for example, without limitation, aluminums, metals, plastics, other materials and combinations thereof.

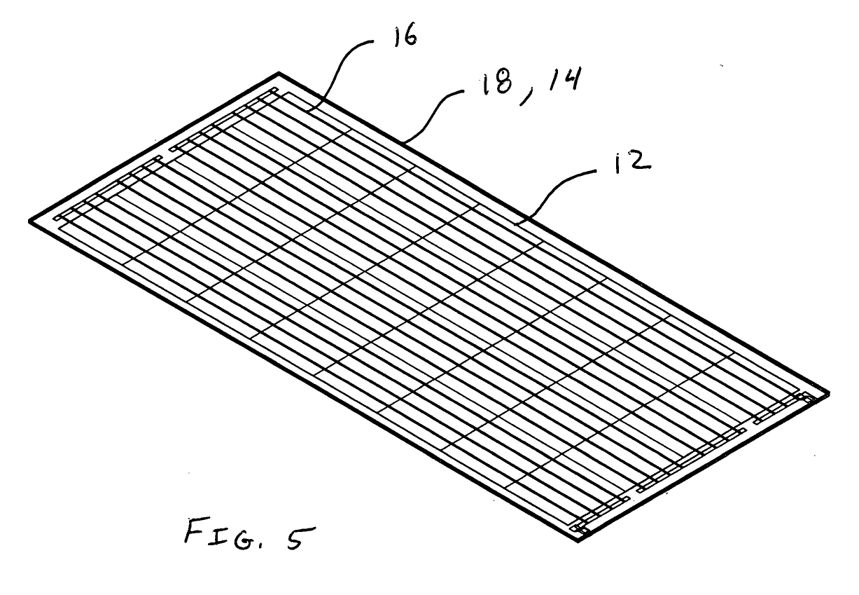

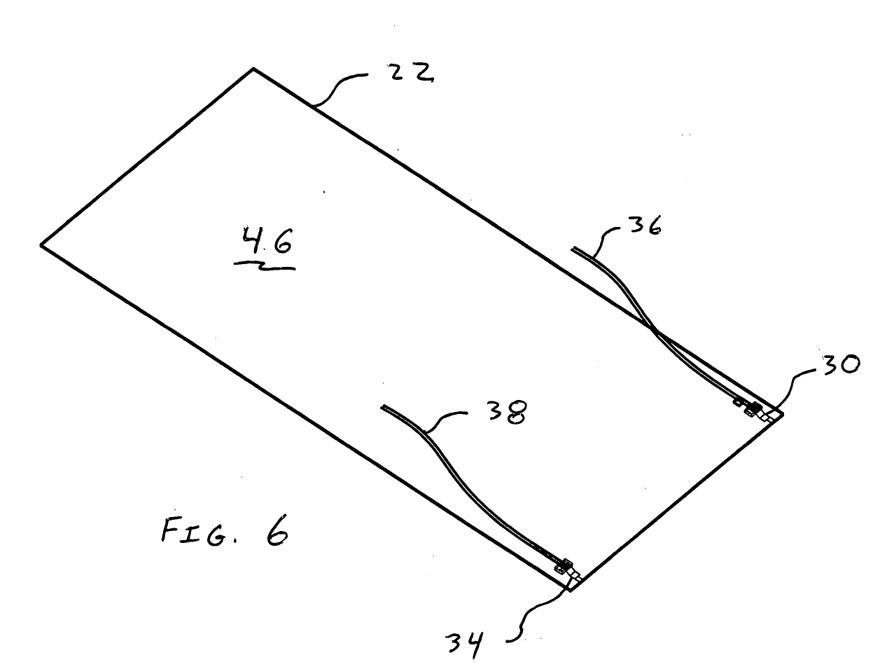

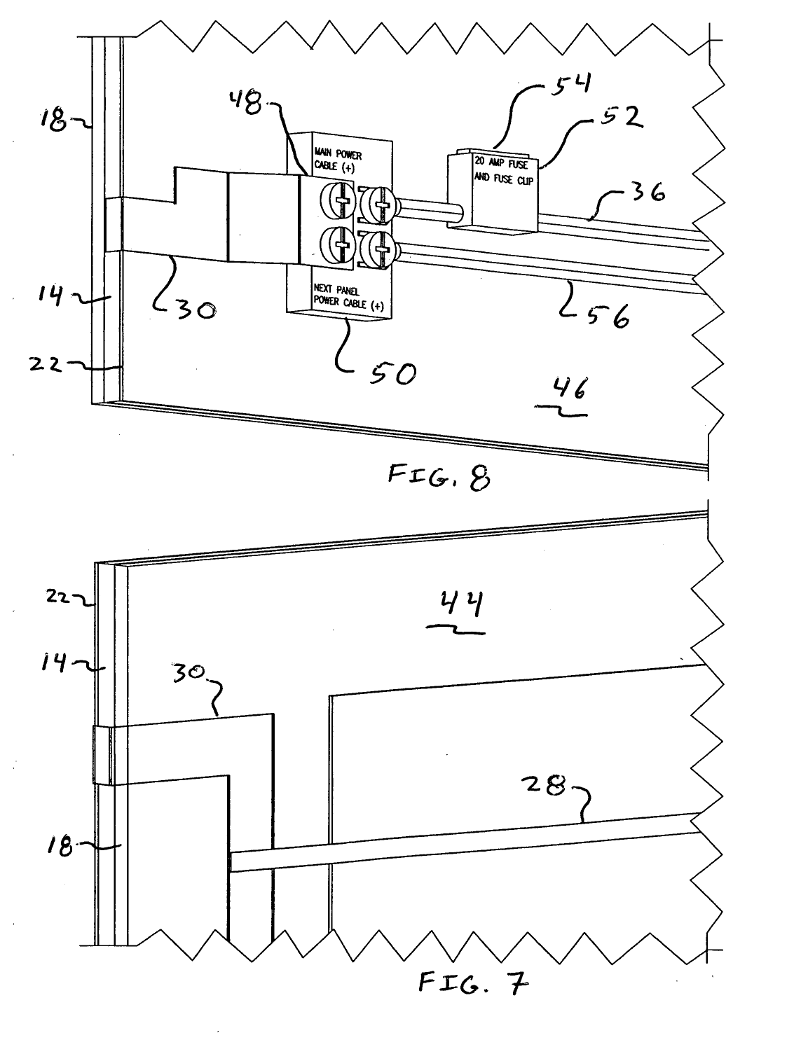

Referring to FIGS. 5-8, the solar defrost panel 10 is shown without the frame 20. FIGS. 5 and 7 show top views of the solar defrost panel 10 and FIGS. 6 and 8 show bottom views of the solar defrost panel 10. The bus bars 30, 34 are main power bus bars which are connected to a power source to operate the electrical heating element 16. As can be seen more clearly in FIGS. 7 and 8, the main power buss bar 30 is bent and rapped around from the top side 42 of the transparent panel 14 to the underside 46 of the solar panel layer 12. The end 48 of the positive main power bus bar 30 is attached to a terminal barrier strip 50 which is attached to the bottom side 46 of the solar panel layer 12. The positive lead 36 having a fuse holder 52 and a fuse 50 is connected to the terminal barrier strip 50 and to the positive feed from the power supply. The fuse 54 provides a safeguard to the electrical components of the solar defrost panel 10 from damage or overheating. A positive connector lead 56 can also be connected to the terminal barrier strip 50 and to another solar defrost panel 10 as will be more fully described below. FIGS. 7 and 8 only show the positive main power bus bar 30 and positive terminal barrier strip 50 for electrical connection to the positive terminal of the power supply. The other negative main power bus bar 34 is similarly bent and wrapped around and is electrically connected to a negative terminal barrier strip which is electrically connected to the negative terminal of the power supply.

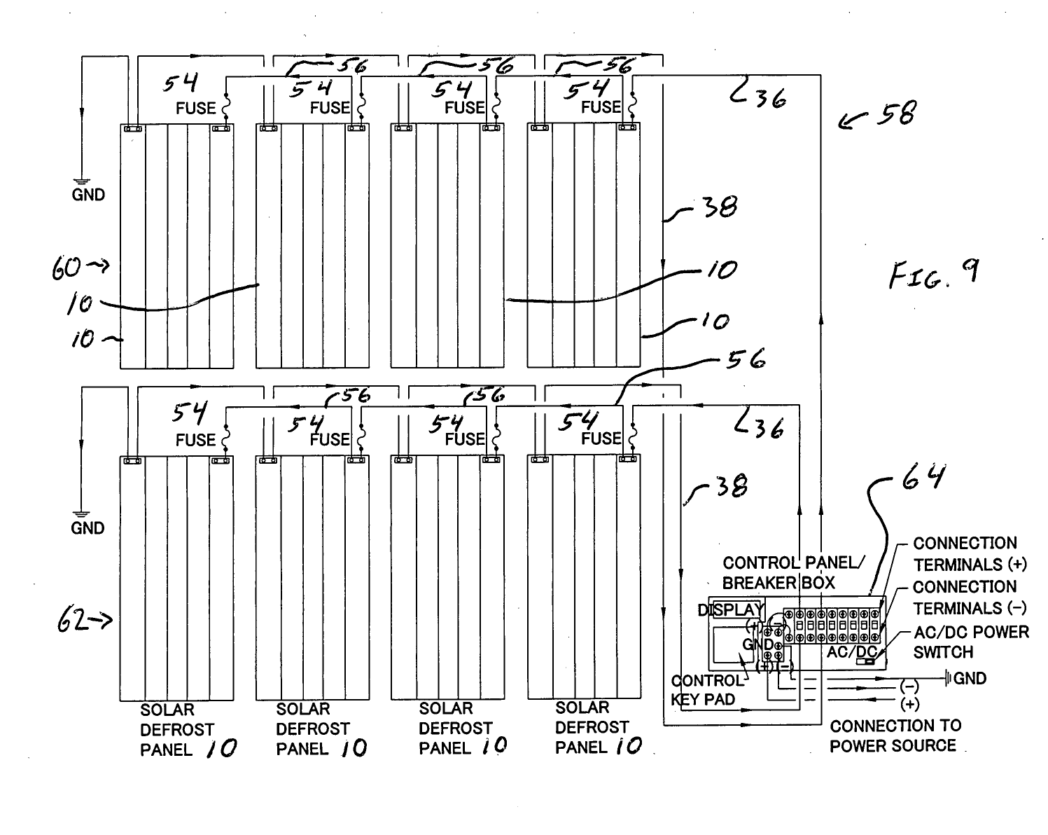

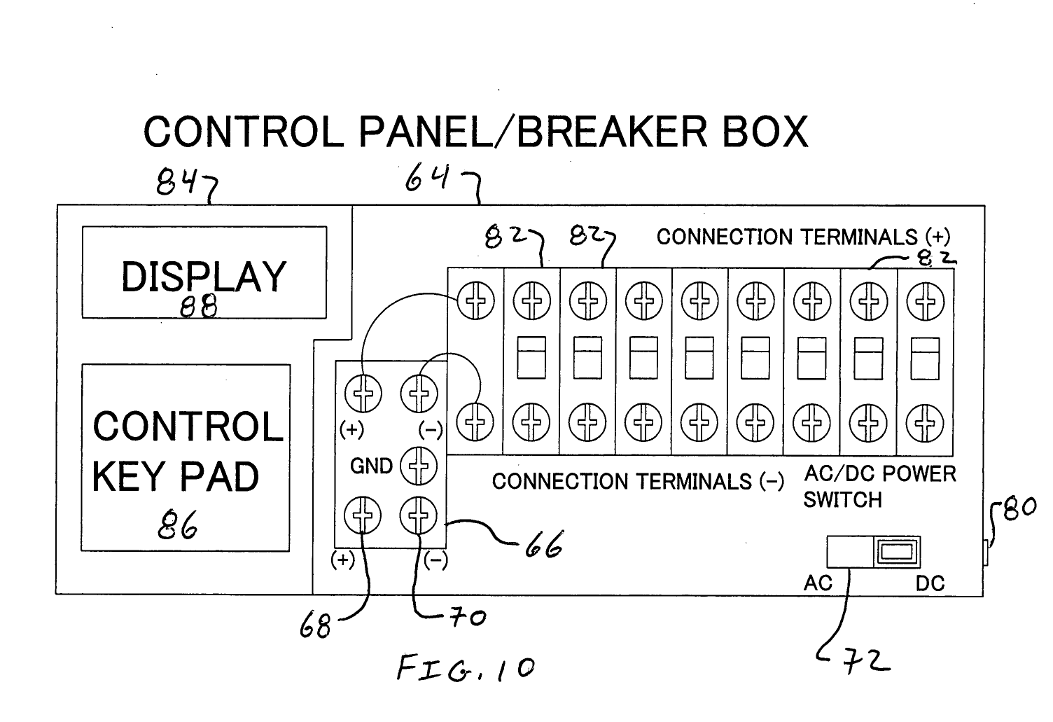

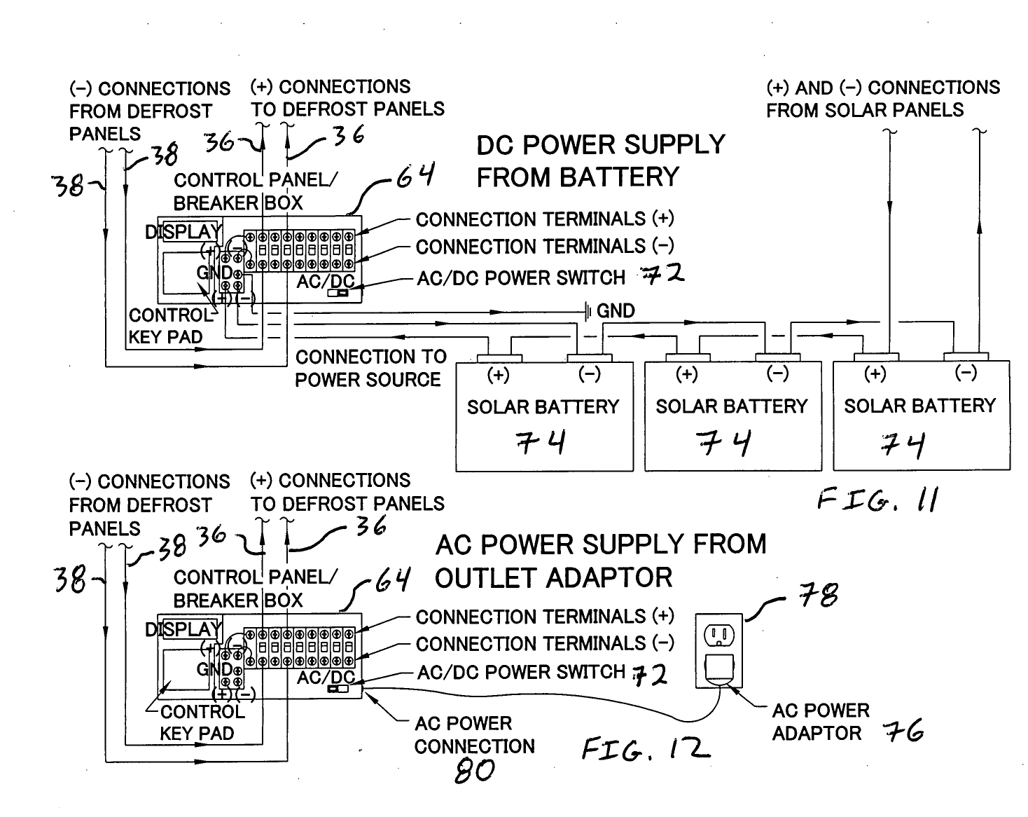

Referring to FIG. 9, a schematic diagram of a solar defrost panel system 58 is shown. The solar defrost panel system 58 has a first array 60 of solar defrost panels 10 and a second array 62 of solar defrost panels 10. The solar defrost panel system 58 has a control panel 64 connected to the first and second arrays 60, 62 for controlling operation of the electrical heater elements 16 in the solar defrost panels 10. The control panel 64 is shown in an enlarged schematic diagram in FIG. 10. The control panel has a main circuit terminal 66 having positive and negative terminals 68, 70 for connection to an electrical power source. A power selector switch 72 can be set to the appropriate power source, AC or DC. The electrical power source can be a DC power, source as the electrical heating elements 16 operate on DC power. Examples of DC power sources include, without limitation, DC batteries (such as DC batteries charged by the solar panel layers 12 or other DC batteries), DC output from the solar panel layer 12, and DC output from an AC to DC converter. FIG. 11 shows a schematic diagram of the control panel 64 connected to the DC batteries 74 that are charged by the solar panel layer 12. The electrical power switch 72 is set to DC power.

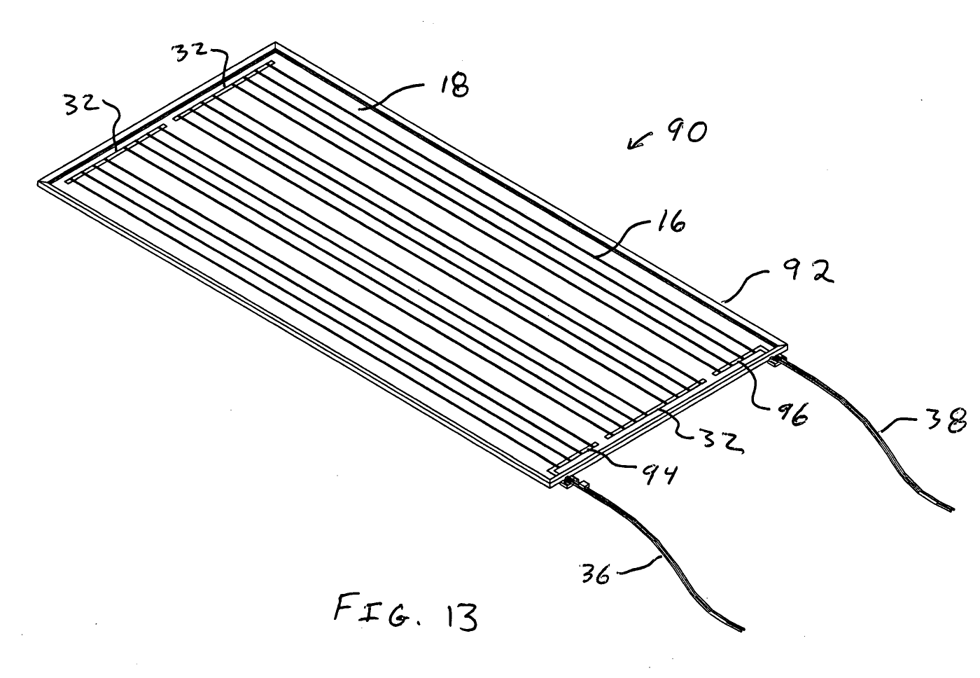

Other embodiments of the present invention could use AC power instead of DC power. For example, FIG. 12 shows a schematic diagram of the control panel 64 connected to AC power. An AC power adapter 76 is plugged into an AC outlet 78 and plugged into an AC power connection 80 of the control panel 64. The control panel 64 can have an AC to DC converter (not shown) for converting the AC power to DC power to run the electrical heating elements 16. The electrical power switch 72 is set to AC power.

Referring to FIGS. 10 and 11, the control panel 64 distributes the DC power from the main circuit terminal 66 to a plurality of circuit breakers 82. The circuit breakers 82 are connected to the main circuit terminal 66 in series. Each circuit breaker 82 can accommodate one or more solar defrost panels 10, such as the plurality of solar defrost panels 10 which are connected in series for each solar defrost panel array 60, 62. Referring to FIGS. 8-10, the first and second arrays 60, 62 of solar defrost panels 10 are connected to individual circuit breakers 82 of the control panel 64. The positive and negative leads 36, 38 connect the circuit breakers 82 to the first and second arrays 60, 62 of solar defrost panels 10. The solar defrost panels 10 in the first and second arrays 60, 62 are connected together in series. As shown in FIG. 9.

Referring to FIGS. 8 and 9, the positive terminal barrier strip has two positions, one position provides power to the electrical defrost system from the control panel and the second position provides power to the next solar defrost panel 10 in a series circuit. The negative terminal barrier strip has two positions, one position is connected to the negative lead from the control panel. The second position is connected to the negative lead to the next solar defrost panel 10 in a series circuit. If there is just one solar defrost panel 10 or the last solar defrost panel 10 in the series, the second position is to a ground cable.

Referring to FIGS. 9 and 10, the control panel 64 has a controller 84 that controls operation of the electrical heating elements 16. The control panel 64 also has a user interface connected to the controller 84, such as a keypad 86 and display 88, for user interaction with the controller 84. The control panel 64, particularly the controller 84, provides the system functions of operating the electrical heating elements 16. The controller 84 can manually turn on/off the electrical heating elements 16 in an on-demand mode and automatically turn on/off the electrical heating elements 16 in a program mode. The controller 84 can be programmed to run the electrical heating elements 16 for desired periods of time on particular days, similar to HVAC controllers. The controller 84 can be any control mechanism to control operation of the electrical heating elements 16, for example, without limitation, printed circuit boards, microprocessors, mechanical timers, mechanical switches and even a simple on/off switch, etc. The control panel 64 can be located close to the solar defrost panels 10 or remotely from the solar defrost panels 10. Also, the controller 84 and user interface 86, 88 of the control panel 64 can be incorporated within the control panel 64 itself or located remotely from the control panel 64. For example, the controller 84 and user interface 86, 88 can be located inside of a building where it is convenient for a user to interface with the controller 84.

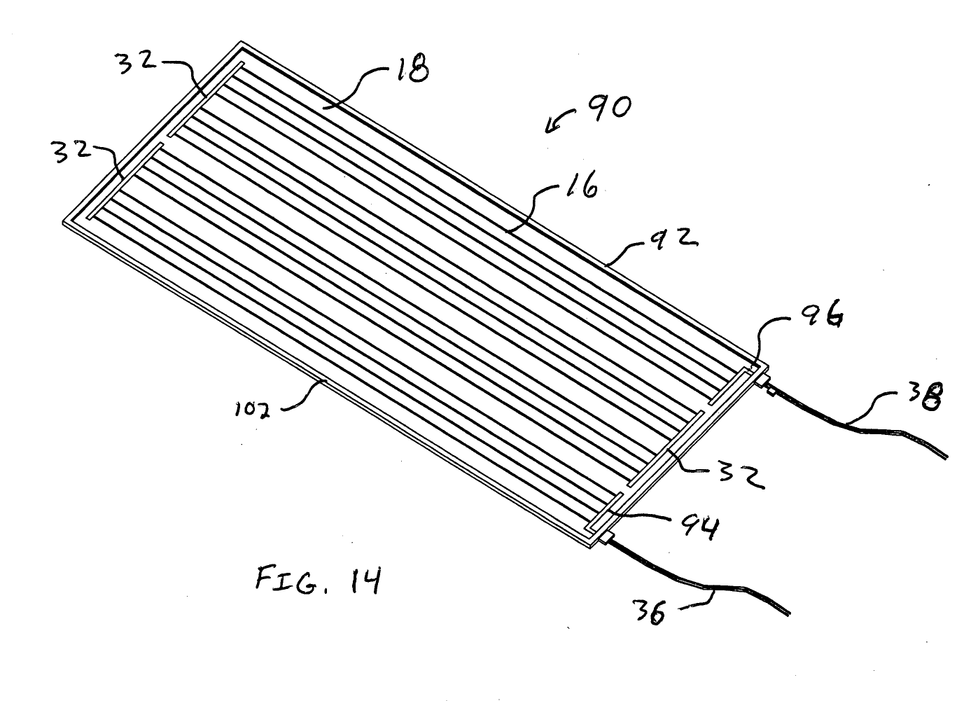

Referring to FIGS. 13-16, another embodiment of the present invention will now be described. In this embodiment, a solar panel defroster 90 is a self contained device which can be added onto an existing solar panel. The solar panel defroster 90 has components which are the same or similar to components shown and described above with reference to FIGS. 1-12 and are assigned like reference numbers. The solar panel defroster 90 has an electrical heating element 16, a transparent panel 18 and a frame 92.

The electrical heating element 16 is the same as the electrical heating element 16 of the solar defrost panel 10, except the positive and negative main power bus bars 94, 96 may not bend and wrap around as in the solar defrost panel 10. Rather, the main power bus bars 94, 96 may extend from an outer edge 98 of the transparent panel 18 for connection to the positive terminal barrier strip 50 and a negative terminal barrier strip 100. The transparent panel 18 is the same as the transparent panel 18 in the solar defrost panel 10.

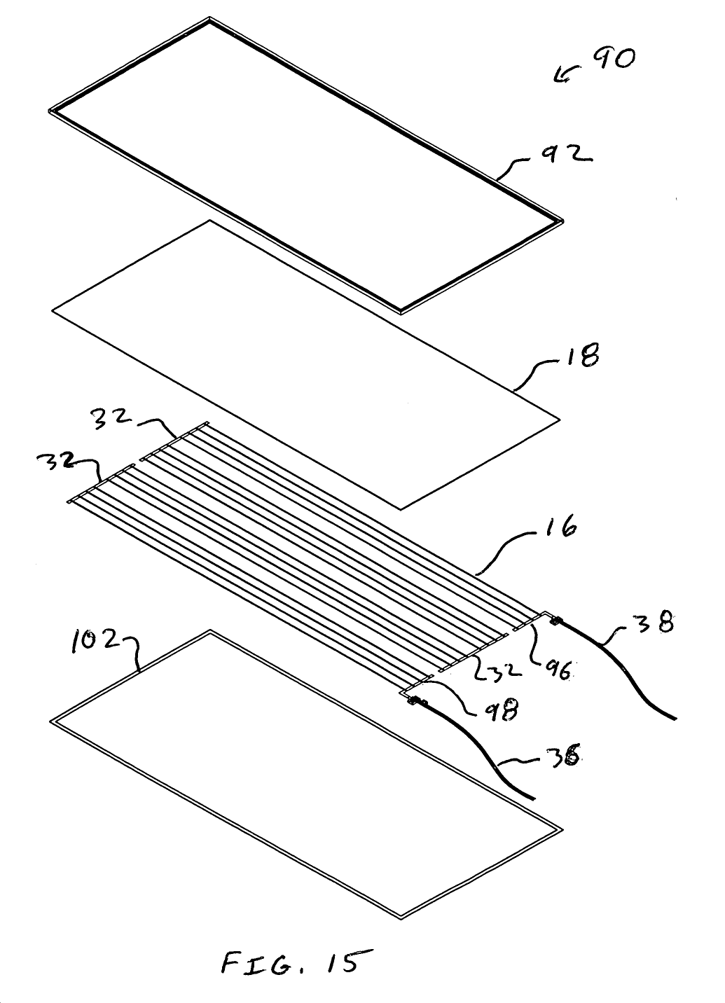

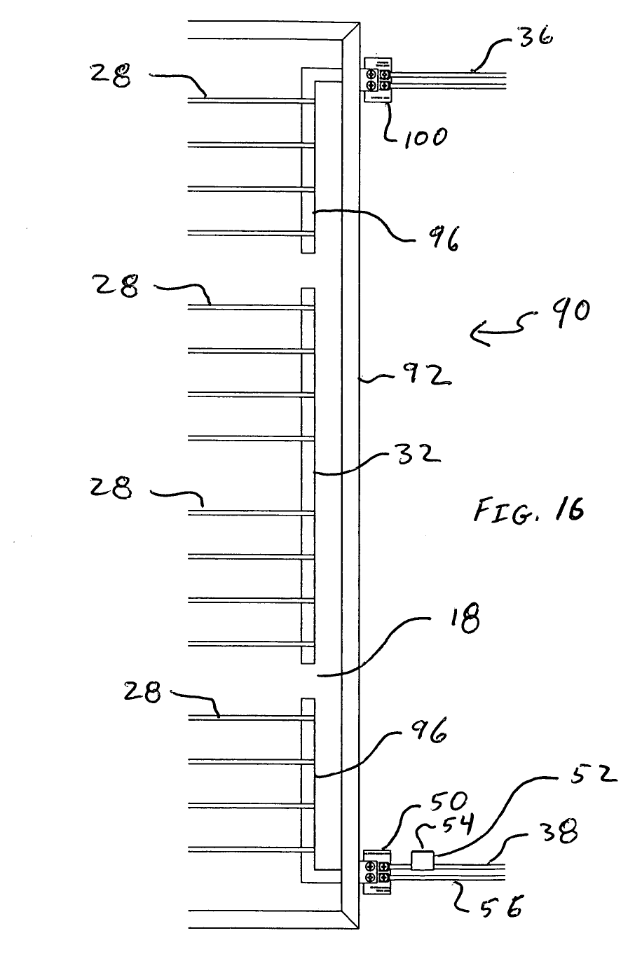

The frame 92 of the solar panel defroster 90 may have a structure to surround only the transparent panel 18 rather than all of the layers of the solar defrost panel 10. The frame 92 may also have brackets or other structures for mounting and securing the solar panel defroster 90 to a solar panel. A seal 102 (FIGS. 14 and 15) may be provided to seal the solar panel defroster 90 against a solar panel. The seal 102 prevents liquids, rain, snow, humidity, dirt, dust and other undesirable materials from entering the space between the solar panel defroster 90 and the solar panel. In the illustrated embodiment, the seal 102 has a shape which conforms to the shape of the frame 92. The seal 102 can be adhered to the bottom side of the frame 92 for sealing against a solar panel. Of course, the seal 102 could have other shapes and could have sealing contact with other portions of the solar panel defroster 90. For example, the seal 102 could seal against the transparent panel 18. The seal 102 can be any type of seal and seal material suitable for its intended purpose, for example, without limitation, rubbers, gaskets, caulks, silicon caulks, etc.

The solar panel defroster 90 may have various uses. For example, without limitation, the solar panel defroster 90 could be used to retrofit existing solar panels. Also, the solar panel defroster 90 could be a modular option that can be added to solar panels if desired. The solar panel defroster 90 can even be added to solar panels after the solar panels have been installed in the field.

An embodiment of the present invention has been shown and described as a solar defrost panel having a rectangular shaped solar panel (photovoltaic panel) having a plurality of photovoltaic cells. However, the present invention is not limited to any particular shape, solar panel, photovoltaic panel or photovoltaic cell. The present invention can be practiced with any device that converts solar energy (sunlight) to another form of energy, such as electrical energy.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A solar defrost panel, comprising:
an energy converter that converts solar energy to electrical energy; and
an electrical heater adjacent the energy converter such that a temperature of at least a portion of the solar defrost panel is increased when the electrical heater is electrically actuated.

2. The solar defrost panel according to claim 1, wherein the electrical heater comprises an electrical resistance heating element.

3. The solar defrost panel according to claim 1, wherein the electrical heater comprises a transparent panel and an electrical resistance heating element on a side of the transparent panel facing the energy converter.

4. The solar defrost panel according to claim 1, wherein
the energy converter comprises:
a photovoltaic panel having a solar exposure side; and
a first transparent panel above the solar exposure side of the photovoltaic panel; and
the electrical heater comprises:
an electrical resistance heating element above the first transparent panel; and
a second transparent panel above the electrical heating resistance element.

5. The solar defrost panel according to claim 1, further comprising a controller operatively connected to the electrical heater and controlling an operation of the electrical heater.

6. The solar defrost panel according to claim 3, further comprising a controller operatively connected to the electrical heater and controlling an operation of the electrical heater.

7. The solar defrost panel according to claim 5, further comprising a controller operatively connected to the electrical heater and controlling an operation of the electrical heater.

8. The solar defrost panel according to claim 2, wherein the electrical heating resistance element comprises a plurality of elongated electrically conductive elements electrically connected together by bus bars.

9. The solar defrost panel according to claim 4, wherein the electrical heating resistance element comprises a plurality of elongated electrically conductive elements electrically connected together by bus bars.

10. The solar defrost panel according to claim 1, further comprising a battery electrically connected to an electrical output of the energy converter; and
wherein the battery is electrically connected to the electrical heater.

11. A solar defrost panel, comprising:
a photovoltaic panel having a solar exposure side;
an electrical conductive heating element above the solar exposure side of the photovoltaic panel;
an electrical insulator between the photovoltaic panel and the electrical conductive heating element; and
a first transparent panel above the electrical conductive heating element.

12. The solar defrost panel according to claim 11, further comprising a second transparent panel between the solar exposure side of the photovoltaic panel and the electrical conductive heating element.

13. The solar defrost panel according to claim 12, wherein the second transparent panel is the electrical insulator.

14. The solar defrost panel according to claim 11, wherein the electrical conductive heating element comprises a plurality of elongated electrically conductive elements electrically connected together by bus bars.

15. The solar defrost panel according to claim 11, further comprising a controller connected to the electrical conductive heating element and controlling operation of the electrical conductive heating element.

16. The solar defrost panel according to claim 15, further comprising a battery electrically connected to an electrical output of the photovoltaic panel; and
wherein the battery electrically powers the electrical conductive heating element during a battery power mode.

17. The solar defrost panel according to claim 15, wherein the electrical conductive heating element is electrically connected to an electrical output of the photovoltaic panel.

18. The solar defrost panel according to claim 15, further comprising an AC to DC converter, wherein a DC output of the AC to DC converter is electrically connected to the electrical conductive heating element.

19. A solar panel defroster, comprising:
a flat transparent panel;
an electrical conductive heating element adjacent the flat transparent panel; and
a frame around an outer edge of the flat transparent panel.

20. The solar panel defroster according to claim 19, wherein the electrical conductive heating element comprises a plurality of elongated electrically conductive elements electrically connected together by bus bars.

21. A method of heating a solar panel, comprising:
supplying electric current to an electrical conductive heating element;
increasing a temperature of the electrical conductive heating element by the electric current passing through the electrical conductive heating element; and
transferring heat energy from the electrical conductive heating element to at least a portion of the solar panel.

22. The method of heating a solar panel of claim 21, wherein the step of transferring heat energy comprises transferring heat energy to an outermost solar exposure portion of the solar panel.

23. The method of heating a solar panel of claim 21, wherein the step of supplying electric current comprises supplying electric current from a battery.

24. The method of heating a solar panel of claim 23, further comprising recharging the battery with electrical output from the solar panel.

25. The method of heating a solar panel of claim 21, wherein the step of supplying electric current comprises supplying electric current from an AC to DC converter.

26. The method of heating a solar panel of claim 22, further comprising controlling operation of the electrical conductive heating element with a programmable controller.

27. A method of operating a defroster of a solar panel, comprising:
turning on an electrical heater of the solar panel;
increasing a temperature of at least a portion of the solar panel with the electrical heater; and
melting frozen water on the solar panel with the portion of the solar panel having the increased temperature.

28. The method of heating operating a defroster of a solar panel of claim 27, further comprising controlling operation of the electrical heater with a programmable controller.

29. A method of making a solar defrost panel comprising overlaying an electrical heater layer on top of a solar energy to electrical energy converter.

30. The method of making a solar defrost panel of claim 29, wherein the overlaying step further comprises overlaying a transparent panel carrying an electrical heater on top of the solar energy to electrical energy converter.

31. The method of making a solar defrost panel of claim 29, further comprising assembling the electrical heater layer and the solar energy to electrical energy converter together within a frame.

32. The method of making a solar defrost panel of claim 29, wherein the overlaying step further comprises retrofitting the electrical heater layer onto a solar panel having the solar energy to electrical energy converter.
